(19) United States
(12) Patent Application Publication
(10) Pub. No.: US 2016/0018085 A1
(43) Pub. Date: Jan. 21, 2016

(54) COMPOUND LIGHT CONTROL LENS FIELD

(71) Applicant: SORAA, INC., FREMONT, CA (US)

(72) Inventors: RONALD RANDALL VAN THIEL, FREMONT, CA (US); XUEJIAN LI, FREMONT, CA (US)

(21) Appl. No.: 14/804,060

(22) Filed: Jul. 20, 2015

Related U.S. Application Data
(60) Provisional application No. 62/026,305, filed on Jul. 18, 2014.

(51) Int. Cl. F21V 17/02; F21V 5/00; F21V 17/10; F21V 17/06; F21V 19/02; F21V 5/02; F21V 5/04

(52) U.S. Cl. CPC F21V 17/02; F21V 5/02; F21V 5/008; F21V 5/045; F21V 17/06; F21V 19/02; F21V 17/105

(57) ABSTRACT

A light control apparatus comprising a first region, a second region and a connector rotationally coupling the first region to the second region, wherein a cumulative refraction angle is selectable based upon a relative rotation angle of the first region with respect to the second region and wherein a rotation angle with respect to the first and second region and an axis controls a steering of a light beam.

### REFERENCE TO RELATED APPLICATION

This application is based on and claims priority to U.S. Provisional Application No. 62/026,305, filed Jul. 18, 2014, incorporated herein by reference.

### FIELD OF INVENTION

The disclosure relates to the field of LED illumination systems and more particularly to compound light control lens attachments.

### BACKGROUND

Most illumination applications require some control of the light attributes (e.g., direction or intensity). Many illumination applications control light direction using a mechanical gimbal.

Legacy gimbals rely on a mechanical mount to which is mounted an optical system (e.g., camera or lens or illumination source). Such a mechanical gimbal mount permits a rotation of the optical system about a central axis. Such a mechanical gimbal mount also permits a rotation of the optical system off of the central axis. However, as the optical system and mount are rotated through off-axis angles, the excursion requires a large amount of lateral clearance.

Unfortunately, not all illumination applications have a sufficient physical clearance to accommodate the off-axis rotation of the mechanical gimbal mount and its optical system. Therefore, there is a need for improved approaches to controlling light direction without requiring the physical space of a mechanical gimbal. The present invention fulfills this need among others.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Described herein is a light control apparatus comprising a first region, a second region and a connector rotationally coupling the first region to the second region, wherein a cumulative refraction angle is selectable based upon a relative rotation angle of the first region with respect to the second region.

Further described herein is a method for controlling a light beam generated by a lamp comprising passing the light beam through a first refractive region and a second refractive region, said first and second refractive regions generating a composite refraction angle for the light selectable by a relative rotation of the first refractive region with respect to the second refractive region

### BRIEF DESCRIPTION OF THE DRAWINGS

Those skilled in the art will understand that the drawings, described herein, are for illustration purposes only. The drawings are not intended to limit the scope of the present disclosure.

FIG. 1A presents an exploded view of an illumination application using a compound light control lens attachment, according to some embodiments.

FIG. 1B depicts a two-element compound light control lens attachment, according to some embodiments.

FIG. 1C1, FIG. 1C2, and FIG. 1C3 present various views showing the structure of a first lens element, according to some embodiments.

FIG. 2A and FIG. 2B present diagrams of a two-element compound light control lens attachment adjusted to provide a large light direction angle, according to some embodiments.

FIG. 3A and FIG. 3B present diagrams of a two-element compound light control lens attachment adjusted to provide a small light direction angle, according to some embodiments.

FIG. 4A, FIG. 4B, and FIG. 4C present diagrams illustrating the connector attributes of a two-element compound light control lens attachment that accommodates connection and adjustment of the lens elements, according to some embodiments.

FIG. 5 presents a diagram illustrating light direction angle settings to aid in the use of a compound light control lens attachment, according to some embodiments.

FIG. 6A, FIG. 6B, FIG. 6C, and FIG. 6D depict texturing treatments, coating treatments, and scalloping applied to the lens elements of a compound light control lens attachment, according to some embodiments.

FIG. 7A depicts an embodiment of the present disclosure in the form of a lamp application.

FIG. 8A depicts a light control apparatus according to one embodiment.

FIG. 8B depicts a rotation of a compound structure comprised of several regions.

FIG. 8C depicts a side view of a light control apparatus according to one embodiment.

FIG. 8D is a block diagram of a light control apparatus according to one embodiment.

FIG. 9 is a flowchart of an operation of a light control apparatus according to one embodiment.

### DETAILED DESCRIPTION

Reference is now made in detail to certain embodiments. The disclosed embodiments are not intended to be limiting of the claims.

According to one embodiment, a light control apparatus comprises a first region, a second region; and a connector rotationally coupling the first region to the second region, wherein a cumulative refraction angle is selectable based upon a relative rotation angle of the first region with respect to the second region.

According to one embodiment a method for controlling a light beam generated by a lamp comprises passing the light beam through a first refractive region and a second refractive region, said first and second refractive regions generating a composite refraction angle for the light selectable by a relative rotation of the first refractive region with respect to the second refractive region.

The embodiments of the present disclosure relate to a compound light control lens attachment having a plurality of connected lens elements arranged and adjusted to provide control of light attributes (e.g., direction, intensity, etc.) of an illumination source (e.g., LED lamp). Some embodiments of the present disclosure provide light direction control. The light direction control is achieved by refraction of the light from the illumination source as it passes through each lens element. The angle of refraction in each element is dictated by the physical profile and material of each lens element. The cumulative angle of the light beam passing through the entire compound light control lens attachment depends on the properties and relative position of each lens element. The angled light beam can further be adjusted in a conical pattern by rotating the compound light control lens attachment relative to the illumination source fixture. The compound light control lens attachment fits within the footprint of the illumination source fixture, thereby providing light direction control without requiring the additional physical space of conventional mechanical gimbals.

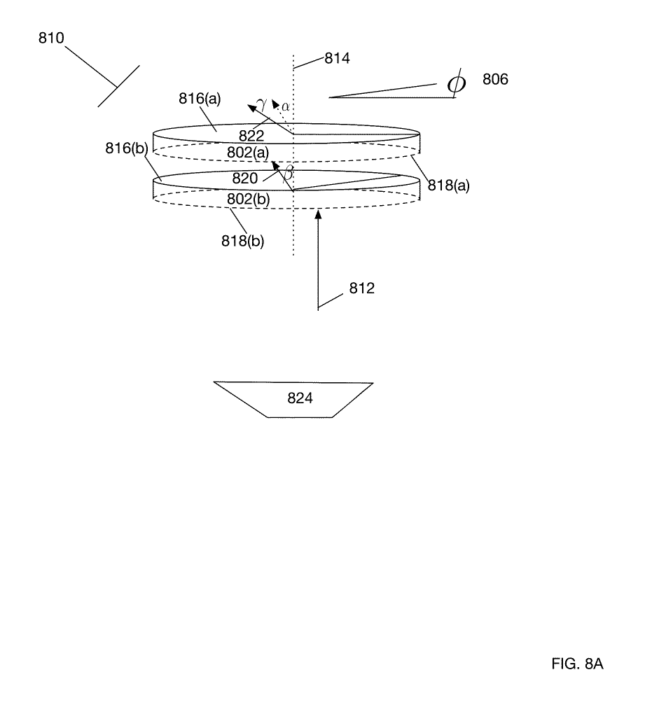

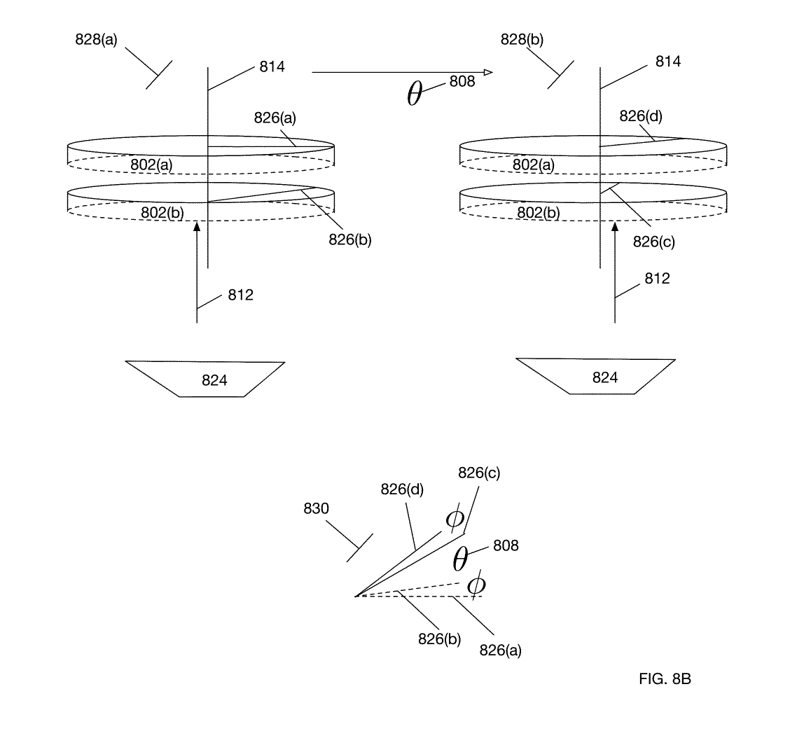

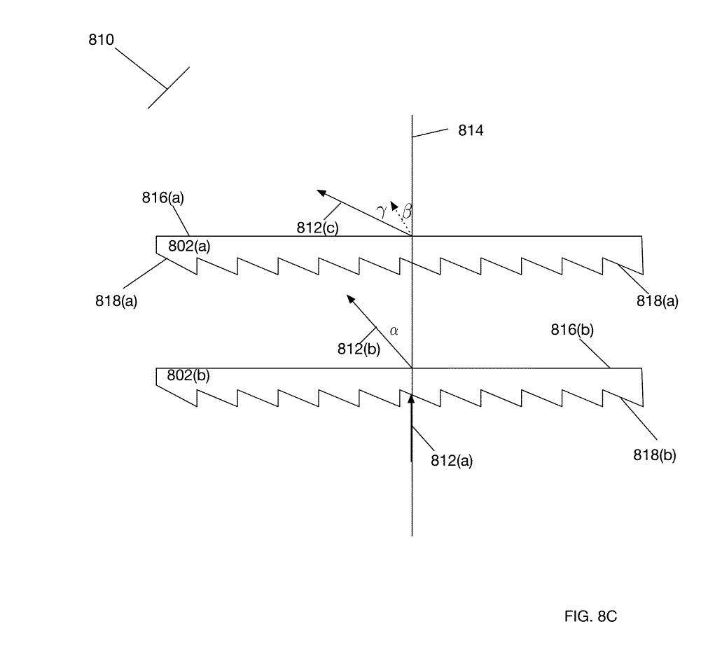

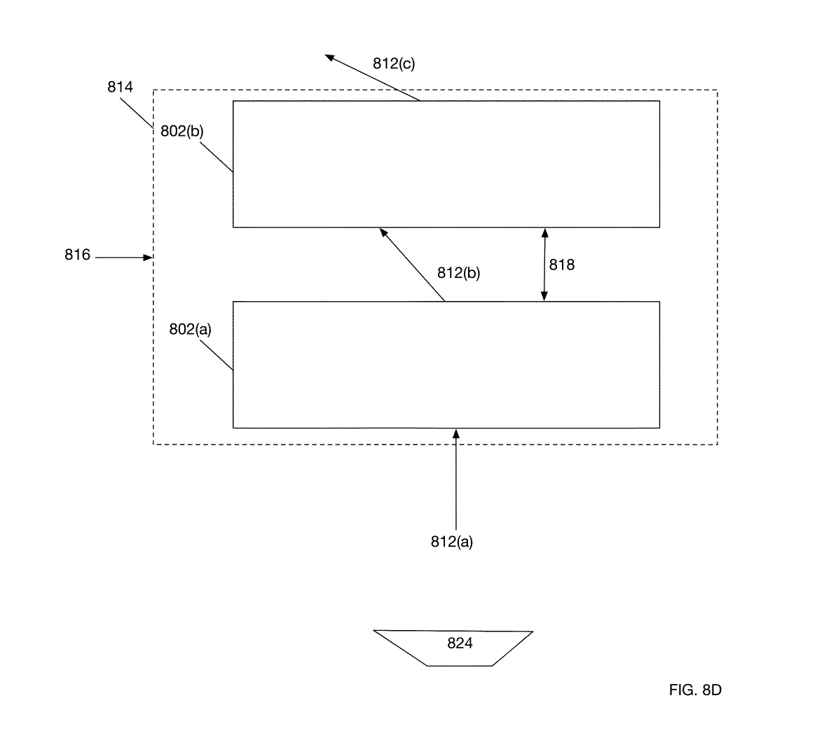

FIG. 8D is a block diagram of a light control apparatus according to one embodiment. Light control apparatus comprises compound structure 814, which further comprises regions 802(a) and 802(b). Although FIG. 8D depicts only two regions 802(a) and 802(b) for illustration purposes, compound structure 814 may comprise an arbitrary number of regions. It is understood that the structure and function of compound region as described herein would apply to an arbitrary number of regions.

As described in detail below regions 802(a) and 802(b) may assume an arbitrary geometry, aspect ratio and material type. Regions 802(a) and 802(b) may be configured with respect to one another represented by double arrow 818. The configuration of regions 802(a) and 802(b) with respect one another may involve a geometrical configuration of regions 802(a) and 802(b) such as a relative rotation of region 802(a) with respect to region 802(b). In addition, configuration of regions 802(a) and 802(b) with respect to one another may involve any other attributes of regions 802(a) and 802(b).

According to one embodiment, the configuration of regions 802(a) and 802(b) relative to one another controls a steering of incident light represented by ray 812(a) generated by illumination source 824. In particular, as depicted in FIG. 8D, incident light represented by ray 812(a) interacts with compound structure 814 comprising regions 802(a) and 802(b) where it ultimately assumes a cumulative direction represented by ray 812(c). Incident light 812(a) may assume any number of intermediary transformations such as a change in direction represented by ray 812(b) during interaction with compound structure 814.

According to one embodiment, compound structure 814 may also be configured via compound structure configuration 816 independently of configuration of regions 802(a) and 802(b) relative to one another. The combination of relative configuration parameters 818 between regions 802(a) and 802(b) and compound structure configuration parameters 816 provide two independent degrees of freedom for controlling the steering and direction of incident light 812(a).

FIG. 8A depicts a light control apparatus according to one embodiment. The arrangement depicted in FIG. 8A is intended to illustrate the functional elements of a light control apparatus according to one embodiment. According to one embodiment, light control apparatus 810 comprises the compound structure of regions 802(a) and 802(b). Although FIG. 8A depicts regions 802(a) and 802(b) as cylindrical structures, this is merely exemplary and not intended to limit the scope of the invention. Regions 802(a) and 802(b) may assume any shape. Regions 802(a) and 802(b) may each respectively include a planar surface (816(a) and 816(b)) and a second surface (818(a) and 818(b)), which may be planar non-planar or non-flat. Planar surfaces 816(a) and 816(b) may be perpendicular to axis 814.

According to one embodiment, regions 802(a) and 802(b) may be rotationally coupled via a coupling apparatus (not shown in FIG. 8A) through which regions 802(a) and 802(b) may be rotated around axis 814 with respect to one another. Through this arrangement, a selectable relative angle of rotation φ may be established between regions 802(a) and 802(b). According to one embodiment, selectable relative angle of rotation φ between regions 802(a) and 802(b) controls a cumulative refraction angle γ by which incident light 812 is directed. Refraction angle γ is composed of the superposition of refraction angles α, β respectively introduced by elements 802(a) and 802(b).

In particular, referring to FIG. 8A, according to one embodiment, illumination source 824 generates incident light represented by ray 812. Illumination source 824 may be any light source such as a lamp or LED. Incident light represented by ray 812 traverses second surface 818(b), region 802(b) and planar surface 816(b), where it develops a refraction angle β with respect to axis 814 represented by ray 820. The refracted light represented by ray 820 then traverses first surface 818(a), region 802(a) and planar surface 816(a), where it develops an additional refraction angle α with respect to axis 814. A cumulative refraction angle γ=α+β of the light represented by ray 822 is thus developed.

According to one embodiment, the angled light beam represented by ray 822 can further be adjusted in a conical pattern by rotating the compound structure of regions 802(a) and 802(b) around axis 814 and thus relative to illumination source 824. In particular, FIG. 8B depicts a rotation of the compound structure of regions 802(a) and 802(b). FIG. 8B shows initial configuration 828(a) of regions 802(a) and 802(b). Reference lines 826(a) and 826(b), in initial configuration 828(a) are not part of the invention but merely for illustration purposes to show a relative rotation angle φ that is developed between regions 802(a) and 802(b). As described previously with respect to FIG. 8A, relative rotation angle φ controls a cumulative refraction angle γ by which incident light 812 is directed.

Regions 802(a) and 802(b) as a compound structure may then be rotated together by an arbitrary angle θ around axis 814 and thereby with respect to illumination source 824 to assume rotated configuration 828(b). Reference lines 826(a) and 826(b), in rotated configuration 828(b) are not part of the invention but merely for illustration purposes to show the transformation of relative rotation angle φ between regions 802(a) and 802(b) after the rotation. Note that relative rotation angle φ remains fixed between initial configuration 828(a) and rotated configuration 828(b). This situation is also depicted via rotation diagram 830 in FIG. 8B.

Thus, the combination of the rotational coupling of regions 802(a) and 802(b) in conjunction with the rotation of the compound structure of regions 802(a) and 802(b) with a fixed relative rotation angle φ provides two separate degrees of freedom to control the direction and steering of incident light 812. Namely, the two degrees of freedom are relative rotation angle φ and compound structure rotation angle θ.

FIG. 8C depicts a side view of a light control apparatus according to one embodiment. Regions 802(a) and 802(b) each may comprise respective planar surfaces (816(a) and 816(b)) and second surfaces (818(a) and 818(b)), which may be non-planar as illustrated in FIG. 8C. Regions 802(a) and 802(b) are shown as separated from one another in FIG. 8C for illustration purposes only. In fact, regions 802(a) and 802(b) may be flush with one another. Further, non-planar surfaces 818(a) and 818(b) are shown as sawtooth patterns. The sawtooth pattern depicted in FIG. 8C is merely exemplary and a myriad of non-planar geometries are possible for regions 802(a) and 802(b). Further, regions 802(a) and 802(b) may exhibit heterogeneous geometries with respect to one another.

The combination of a planar surface 816(a) and 818(a) provides region 802(a) with a prismatic structure. Similarly the combination of a non-planar surface combination of a planar surface 816(b) and 818(b) provides region 802(b) with a prismatic structure. Each region 802(a) and 802(b) may therefore impose a respective refraction angle on incident light 812(a) (α, β), the cumulative effect of which yields a cumulative refraction angle γ=α+β such that incident light 812(a) is refracted by region 802(b) to generate first refracted light depicted by ray 812(b) and first refracted light is then refracted by region 802(b) to generate second refracted light depicted by ray 812(c). As described with reference to FIG. 8B above, a relative rotation angle developed between regions 802(a) and 802(b) yields a desired cumulative refraction angle for incident light.

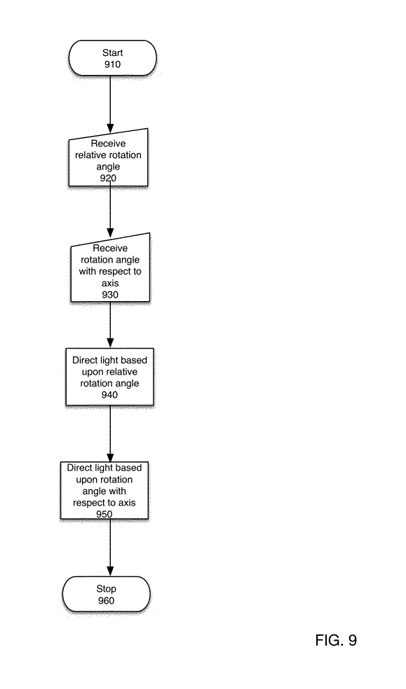

FIG. 9 is a flowchart of an operation of a light control apparatus according to one embodiment. The process is initiated in 910. In 920 a relative rotation angle is received, which may correspond to a rotation of a first region with respect to a second region. In 920, a rotation angle with respect to an axis is received. In 940, a light beam is directed based upon the relative rotation angle. In 950, the light beam is further directed based upon the rotation angle with respect to the axis. The process ends in 960.

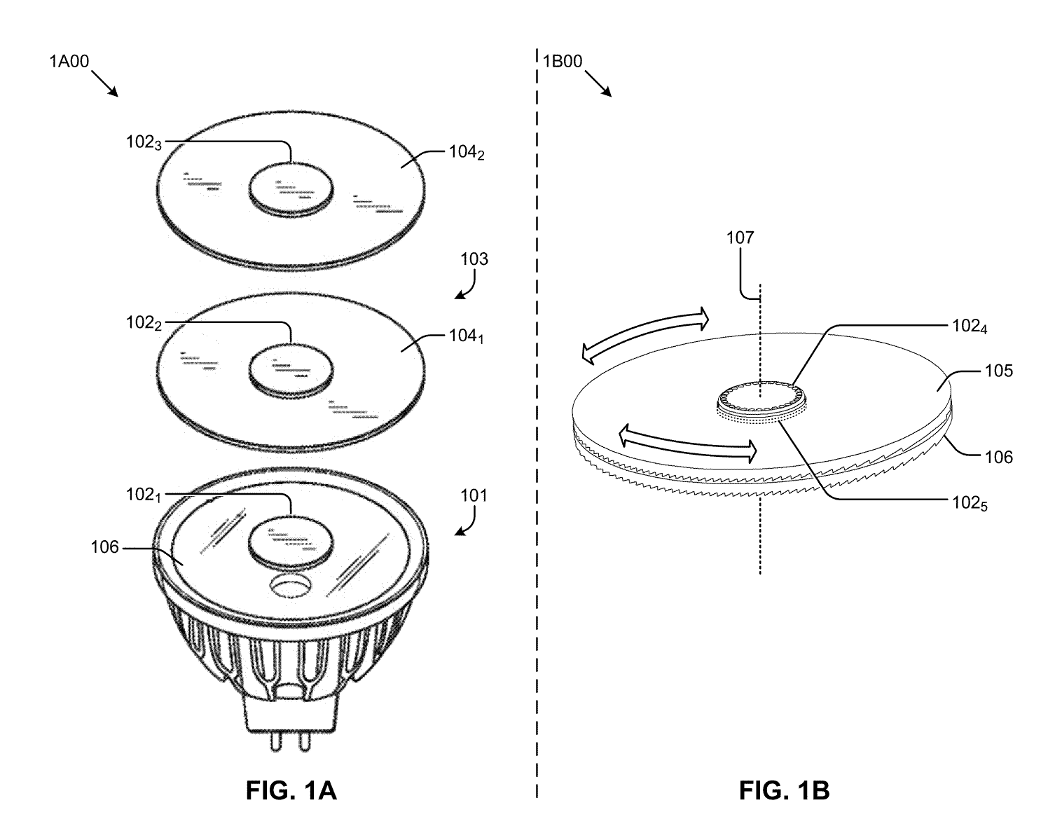

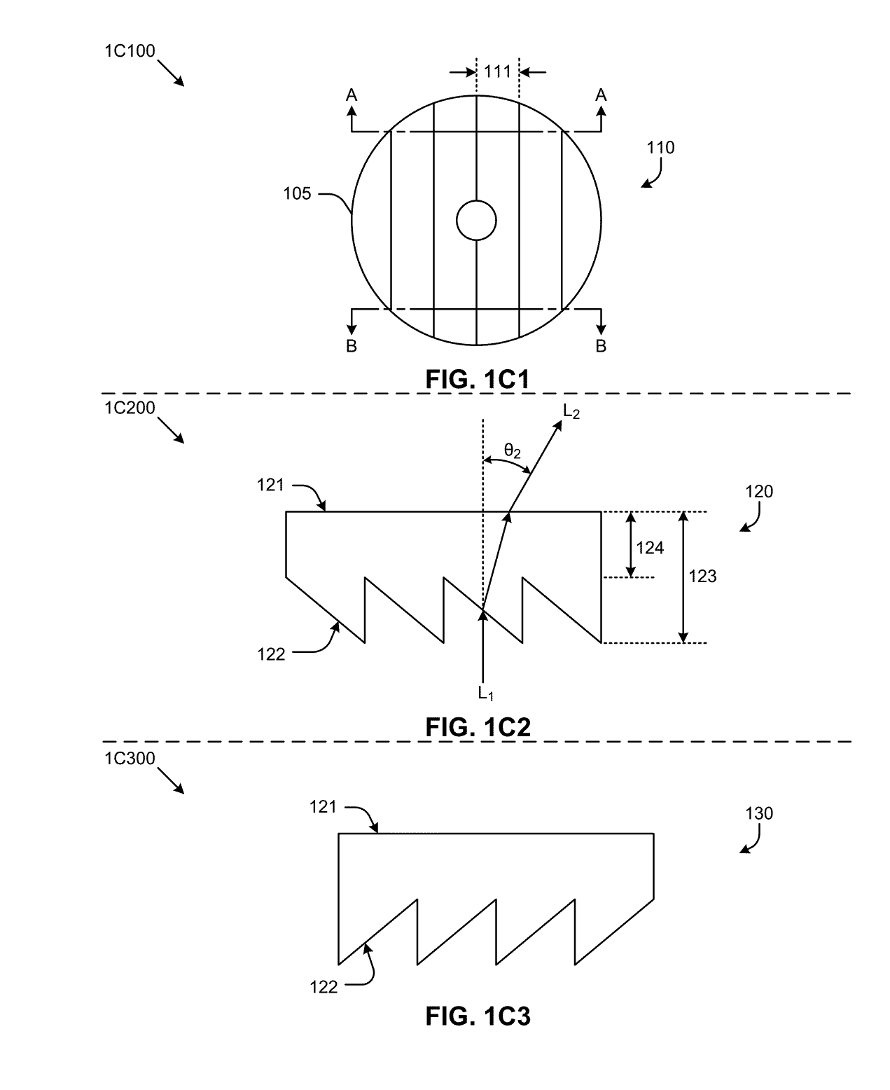

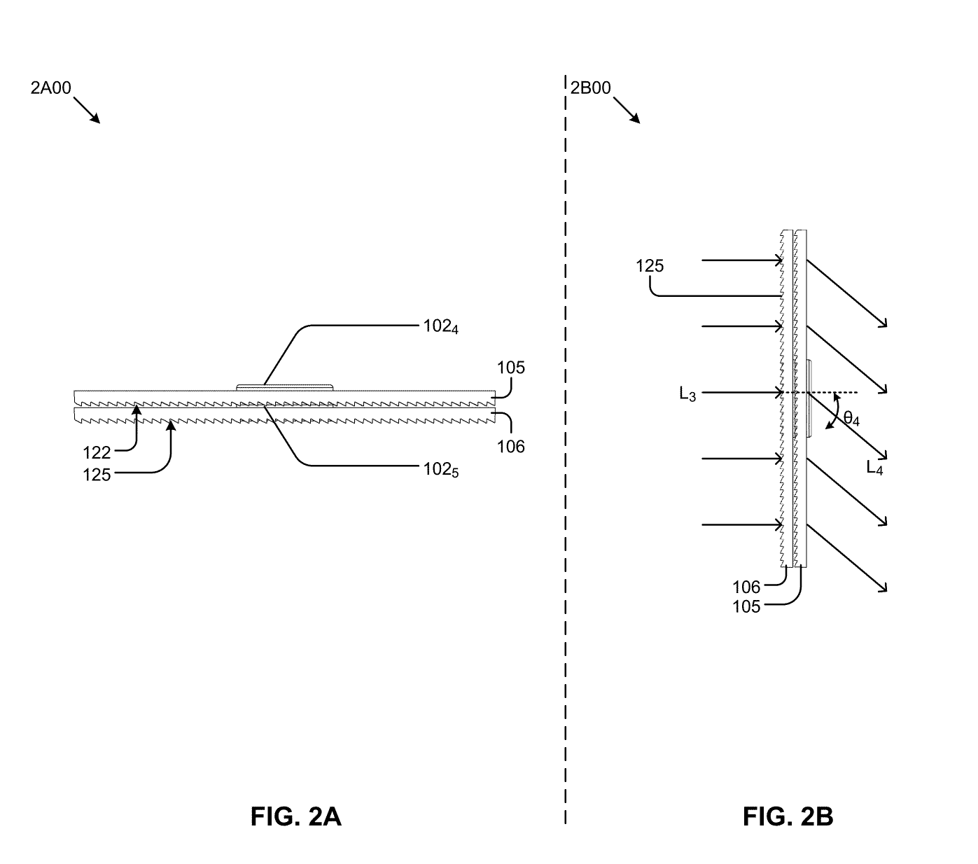

FIG. 1A presents an exploded view of an illumination application 1A00 using a compound light control lens attachment. Illumination application 1A00 comprises a lamp 101 to hold and protect an illumination source device (e.g., LED) and connect to a power source. For applications with limited physical space, lamp 101 is designed to fit tightly into that space with no allowance for movement. Lamp 101 includes a transparent safety lens 106 to prevent damage to or from unintended contact with components of lamp 101. Lamp 101 provides light in a direction substantially normal to the surface of safety lens 106.

Illumination application 1A00 further comprises a compound light control lens attachment 103 configured to fit and attach to lamp 101. Lens attachment 103 comprises lens elements 104₁ and 104₂, each with an element connector 102₂ and 102₃, respectively, to hold lens elements 104₁ and 104₂ in a fixed relationship with one another. Safety lens 106 also includes an element connector 102₁ to receive and attach lens attachment 103 to lamp 101. More detail on one embodiment of lens attachment 103 is provided in subsequent figures and their descriptions.

FIG. 1B depicts a two-element compound light control lens attachment 1B00. Compound light control lens attachment 1B00 comprises a first lens element 105 with a first element connector 102₄, and a second lens element 106 with a second element connector 102₅ (hidden view). First lens element 105 and second lens element 106 are circular in shape and aligned such that their centers lie on a common axis 107. First lens element 105 is attached to second lens element 106 by element connectors 102₄ and 102₅ such that lens elements 105 and 106 can remain in a stable, fixed relative position but also can be made to rotate relative to each other around axis 107. Element connectors 102₄ and 102₅ therefore require a low-profile connection mechanism that allows for both stable fixed relative positioning of connected elements as well as rotation of connected elements. One such connection mechanism utilizes magnetism. Compound light control lens attachment 1B00 can also rotate around axis 107 as an entire unit with lens elements 105 and 106 remaining in a fixed relative position. In some embodiments, lens elements 105 and 106 have a flat top surface and profiled bottom surface to control the light direction (see FIG. 1C).

FIG. 1C1, FIG. 1C2, and FIG. 1C3 present various views 1C100, 1C200, and 1C300 showing the structure of a first lens element 105. View 1C100 presents a bottom view 110 showing first lens element 105 having parallel grating grooves or chords traversing the entire bottom surface area of first lens element 105. The chord spacing 111 can vary in width depending on the application. The chord spacing 111 is large in view 1C100 and related views for illustrative purposes. Bottom view 110 includes two section lines, A-A and B-B, orthogonal to the chords of first lens elements 105.

View 1C200 presents a first cross-section 120 along section line A-A that further reveals that first lens element 105 has a flat first top surface 121 and a sawtooth-shaped first bottom surface 122. The sawtooth height 123 and the sawtooth depth 124 of first bottom surface 122 can vary depending on the application. A light beam L₁ incident on first bottom surface 122 will be refracted according to the angle of incidence and the index of refraction of first lens element 105, where the angle of incidence is the angle measured between the direction of the light beam and the direction of the normal to the surface or interface on which the light is incident. As illustrated in first cross-section 120, light beam L₁ is refracted twice, a first time as it enters first lens element 105 at first bottom surface 122 and a second time as it leaves lens element 105 at first top surface 121, to yield a light beam L₂ at a refracted angle θ₂ relative to original light beam L₁.

View 1C300 presents a second cross-section 130 along section line B-B that also reveals flat first top surface 121 and sawtooth-shaped first bottom surface 122 of first lens element 105. Since the view of second cross-section 130 is 180 degrees opposite the view of first cross-section 120, the sawtooth pattern shown in second cross-section 130 is a geometric reflection across a vertical axis of the sawtooth pattern shown in first cross-section 120. This change in the sawtooth pattern illustrates the effect of rotating first lens element 105 one-half turn or 180 degrees.

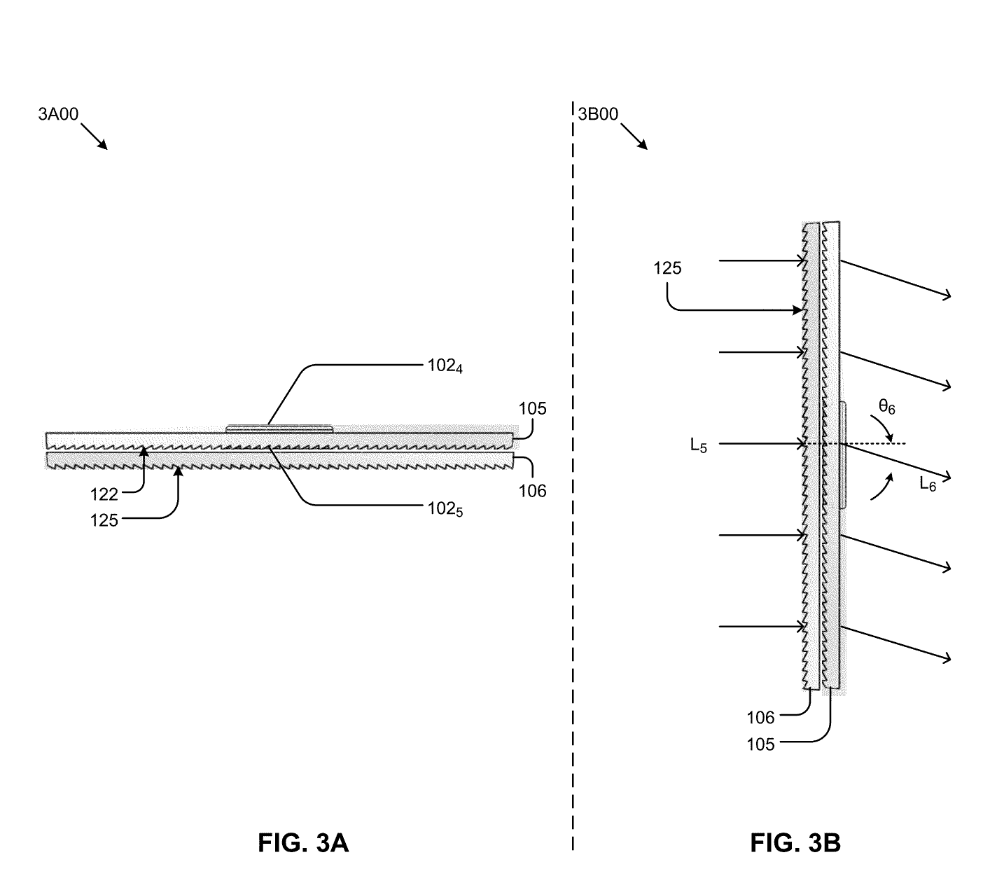

FIG. 2A and FIG. 2B present diagrams 2A00 and 2B00, respectively, of a two-element compound light control lens attachment 1B00 adjusted to provide a large light direction angle. Diagram 2A00 shows a side view of first lens element 105 attached to second lens element 106 by element connectors 102₄ and 102₅ such that the sawtooth patterns of first bottom surface 122 and a second bottom surface 125 of second lens element 106 are geometrically identical (i.e., the sawtooth patterns face the same direction). This configuration can be achieved by rotating first lens element 105 relative to second lens element 106 until the sawtooth patterns of bottom surfaces 122 and 125 are aligned.

As illustrated in diagram 2B00, a light beam L₃ incident on second bottom surface 125 of second lens element 106 will be refracted twice as it enters and leaves second lens element 106 according to the properties of second lens element 106, and then refracted two more times as it passes through first lens element 105 according to the properties of first lens element 105. With the sawtooth patterns of lens elements 105 and 106 aligned, the refraction angles are constructively added to yield a light beam L₄ at a large refracted angle θ₄ relative to original light beam L₃.

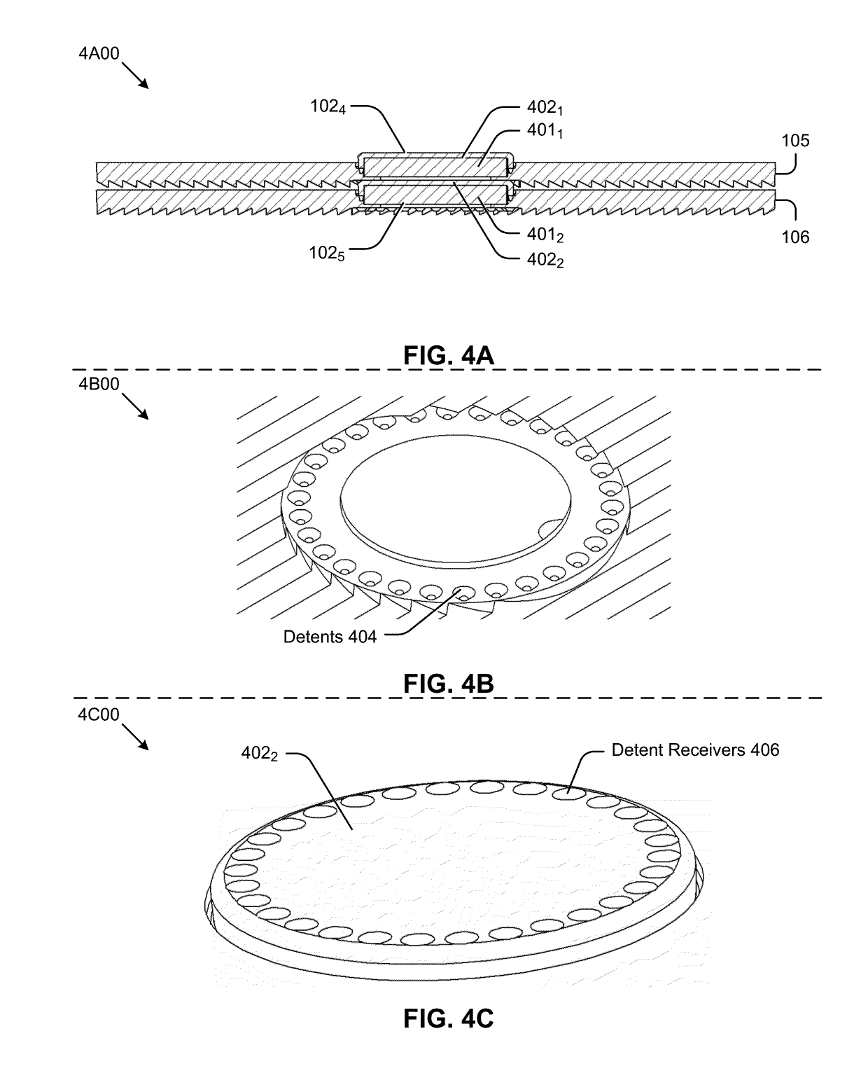

FIG. 3A and FIG. 3B present diagrams 3A00 and 3B00, respectively, of a two-element compound light control lens attachment 1B00 adjusted to provide a small light direction angle. Diagram 3A00 shows a side view of first lens element 105 attached to second lens element 106 by element connectors 102₄ and 102₅ such that the sawtooth patterns of first bottom surface 122 and second bottom surface 125 are a geometric reflection across a vertical axis (i.e., the sawtooth patterns face the opposite direction). This configuration can be achieved by rotating first lens element 105 relative to second lens element 106 until the sawtooth patterns of bottom surfaces 122 and 125 are facing opposite directions.

As illustrated in diagram 3B00, a light beam L₅ incident on second bottom surface 125 of second lens element 106 will be refracted twice as it enters and leaves second lens element 106 according to the properties of second lens element 106, and then refracted two more times as it passes through first lens element 105 according to the properties of first lens element 105. With the sawtooth patterns of lens elements 105 and 106 facing opposite directions, the refraction angles are destructively added to yield a light beam L₆ at a small refracted angle θ₆ relative to original light beam L₅.

In some embodiments of the invention, light control lens attachment utilizes a thin aspect ratio. For instance, the lateral dimension of the attachment may be about 5 cm, and the thickness of the attachment may be about 3 mm. More generally, some embodiments are characterized by a thickness, which is much less than the lateral dimensions (for example, the aspect ratio may be 1:5, 1:10, 1:20, 1:50, 1:100 or others).

This is made possible by the design of the optical lenses, which remain thin in contrast to conventional optical prisms. This may advantageous in situations where space is restricted, and a user wants the ability to steer a beam of light with an accessory having a thin profile.

According to embodiments of the invention, beam steering may occur in a variety of ranges. For instance, in an embodiment where the accessory consists of two steering lenses, the maximum steering range (e.g. the maximum polar angle of light steering) may be determined as the sum of the steering angles of the two lenses. By configuring the two lenses in phase, the angles add. By configuring them 180° out-of-phase, the angles subtract; if the two steering angles are equal, the two steering effects cancel out. In some embodiments, both steering angles are equal to 15°; therefore, by rotating the relative position of the two lenses, steering with polar angles in the range 0° to 30° is possible. Other embodiments use other values, such as 5°, 10 °, 20 °, 45 °.

Various embodiments use a variety of surface configurations to accomplish the beam steering, such as a surface comprising sawtooth patterns, prism patterns, bent or curved prims patters, or other non-planar patterns to bend light trajectories.

In various embodiments, these surface configurations may have a feature depth on the order of 10 um, 100 um, 1 mm, or several mm. The surface configurations may be organized, such as a series of prism grooves running along a large fraction of an optical surface of the accessory; they may be random; they may have a local order with varying lengths scales (such as 10 u, 100 um, 1 mm, 10 mm, 100 mm)

In some cases, very large steering angles may adversely impact the quality of the beam, for instance due to color separation (e.g. wavelength dispersion) or ghosting effects. In some embodiments, this is remedied by additional treatments of the optical lenses, such as surface coatings, texturing or other surface treatments.

In addition, by rotating the accessory with respect to the light source, the azimuthal angle steered beam is rotated in a conical trajectory. In some embodiments, the full range of 0° to 360° is possible.

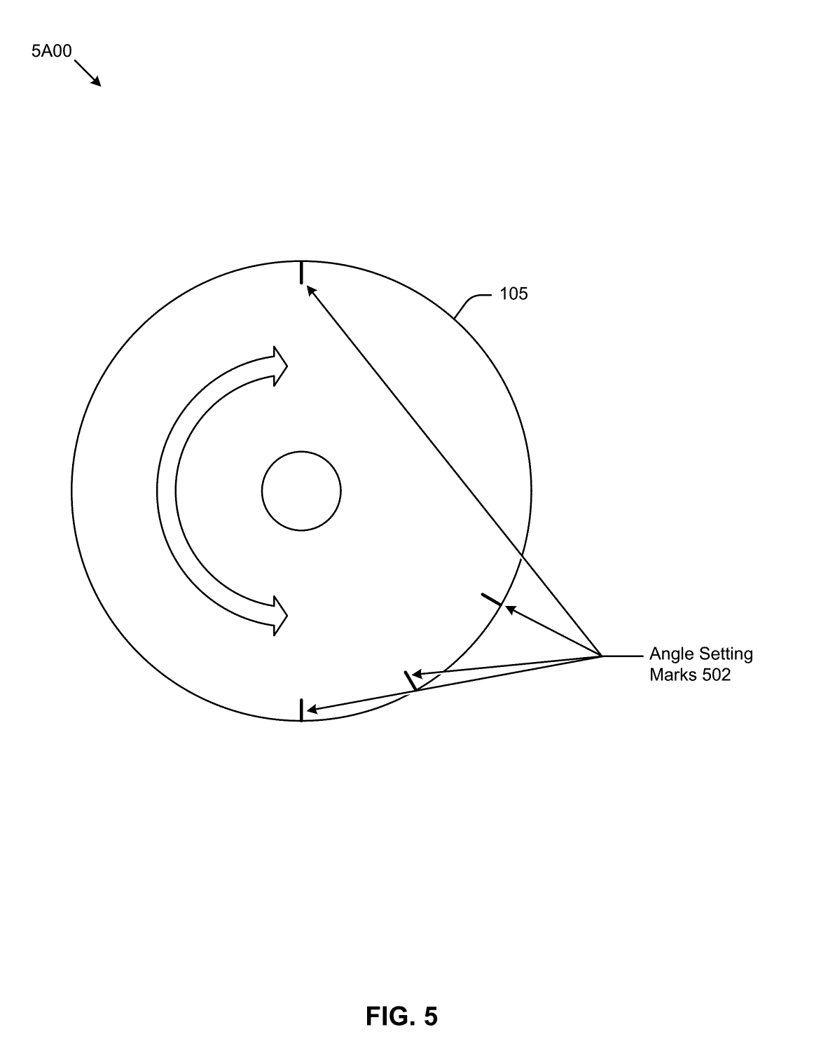

FIG. 4A, FIG. 4B, and FIG. 4C present diagrams 4A00, 4B00, and 4C00, respectively, illustrating the connector attributes of a two-element compound light control lens attachment that accommodates connection and adjustment of the lens elements. Diagram 4A00 shows a cross-sectional view through the center of compound light control lens attachment 1B00 showing first lens element 105 attached to second lens element 106 by element connectors 102₄ and 102₅.

Diagram 4A00 also shows first element connector 102₄ further comprises a first base 401₁ and a first cap 402₁, and second element connector 102₅ further comprises a second base 401₂ and a second cap 402₂. In some embodiments, bases 401₁ and 401₂ are made of magnetic material polarized to provide an attraction force between adjacent element connectors. Caps 402₁ and 402₂ cover bases 401₁ and 401₂, respectively, and separate the magnetic adjacent bases to allow rotation of lens elements relative to one another and provide fixed spacing between adjacent lens elements.

The mechanism for controlling the relative rotation settings of lens elements is illustrated in diagrams 4B00 and 4C00 and the descriptions thereof. Diagram 4B00 shows a detailed perspective view of the bottom center of first lens element 105. Diagram 4B00 shows first lens element 105 comprises a plurality of detents 404 uniformly arranged in a circular pattern having a fixed radius and a center corresponding to the center of first lens element 105. Detents 404 are substantially conical in shape and can be formed (e.g., etched or molded) from the material of first lens element 105 or attached to first lens element 105 in some embodiments.

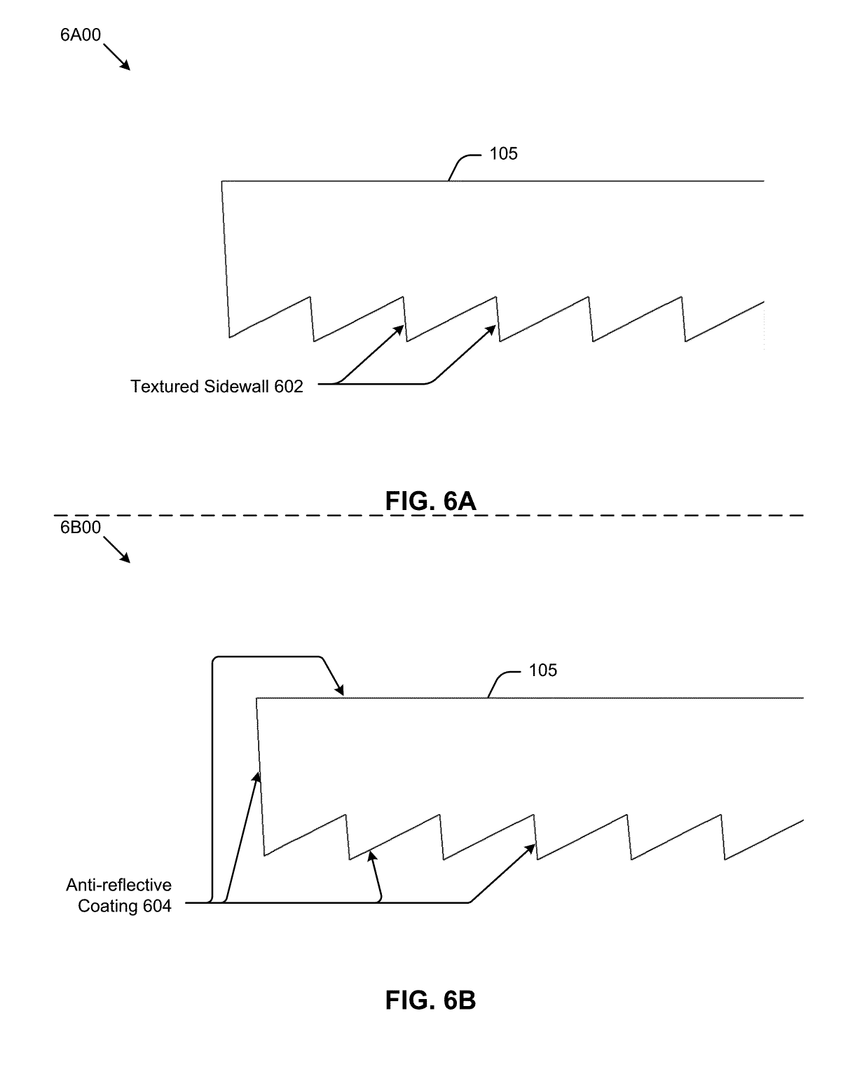

Diagram 4C00 shows a detailed perspective view of the top of second cap 402₂. Diagram 4C00 shows second cap 402₂ comprises a plurality of detent receivers 406 uniformly arranged in a circular pattern having a fixed radius and a center corresponding to the center of second cap 402₂. When the spacing, radius, and center of detents 404 and detent receivers 406 are congruent, detents 404 will mate with detent receivers 406 and hold first lens element 105 in a fixed position relative to second lens element 106. First lens element 105 can then be rotated relative to lens element 106 in increments corresponding to the spacing of detents 404 and detent receivers 406. Using this detent rotational adjustment mechanism, light direction angle settings for compound light control lens attachment 1B00 can be specified (see FIG. 5).

FIG. 5 presents a diagram 5A00 illustrating light direction angle settings to aid in the use of a compound light control lens attachment 1B00. Diagram 5A00 shows a top view of first lens element 105 having a plurality of angle setting marks 502. In some embodiments, angle setting marks 502 correspond to the overall light refraction angle produced by compound light control lens attachment 1B00. The user of compound light control lens attachment 1B00 can then adjust the light direction to the desired angle according to the specified plurality of angle setting marks 502.

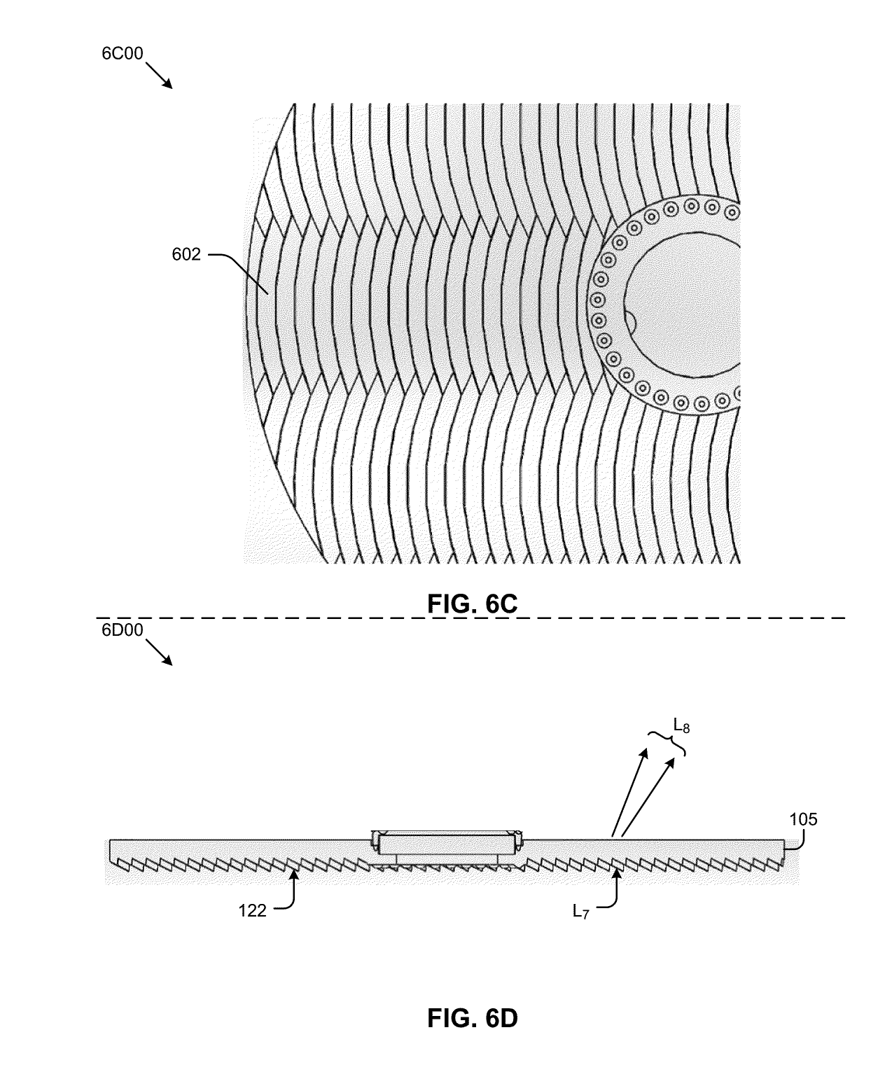

FIG. 6A, FIG. 6B, FIG. 6C, and FIG. 6D depict a diagram 6A00 illustrating texturing treatments, a diagram 6B00 illustrating coating treatments, and diagrams 6C00 and 6D00 illustrating scalloping treatments, respectively, applied to the lens elements of a compound light control lens attachment. Diagram 6A00 shows a cross-sectional view of first lens element 105. In some embodiments, the sawtooth pattern of first lens element 105 has a textured sidewall 602. The properties (e.g., shape, size, etc.) of the texture on textured sidewall 602 influences the distribution of light incident on textured sidewall 602 to improve the attributes (e.g., intensity, color, uniformity, etc.) of the light passing through first lens element 105.

Diagram 6B00 also shows a cross-sectional view of first lens element 105. In some embodiments, several surfaces of first lens element 105 have an anti-reflective coating 604. Anti-reflective coating 604 reduces stray reflected light thereby increasing the efficiency of first lens element 105. A variety of texturing and coating treatments can be applied to any of the lens elements in a given embodiment.

Diagram 6C00 shows a partial bottom view of another embodiment of first lens element 105 that includes a scalloped grating 602. In contrast to the parallel grating shown in view 1C100, scalloped grating 602 comprises a pattern of overlapping curves of radius smaller than the radius of first lens element 105. Diagram 6D00 shows a side view of first lens element 105 having scalloped grating 602, revealing that the grating has a sawtooth-shaped profile. As further shown in diagram 6D00, scalloped grating 602 creates a staggered arrangement of sawtooth patterns that both directs and diffuses a light beam L₇ incident on first bottom surface 122 to yield a diffused light pattern L₈. Desired diffusion attributes can be achieved by varying the size and shape of scalloped grating 602. A variety of scalloping treatments can be applied to any of the lens elements in a given embodiment.

Embodiments of the invention can be applied to a variety of light sources. For instance, this may include various directional lamps (such as PAR, MR and AR form factors and others) and various lighting fixtures comprising a directional light-emitting element. Other embodiments may be embarked in a system, such as an automotive system requiring a light source. In a variety of embodiments, the light source or lighting system comprises a magnetic coupling element, which enables the light-steering accessory to be attached to the lamps; however, other attachment schemes (permanent or removable) are possible.

The aforementioned lamps are merely selected embodiments of lamps that conform to fit with any one or more of a set of mechanical and electrical standards. Table 1 gives standards (see “Designation”) and corresponding characteristics. Any of the lamps described herein and/or in Table 1 can be configured for use with embodiments of a compound light control lens

TABLE 1

| | Base Diameter | | IEC 60061-1 |
|---|---|---|---|
| Designation | (Crest of thread) | Name | standard sheet |
| E05 | 05 mm | Lilliput Edison Screw | 7004-25 |
| | | (LES) | |
| E10 | 10 mm | Miniature Edison Screw | 7004-22 |
| | | (MES) | |
| E11 | 11 mm | Mini-Candelabra Edison | (7004-06-1) |
| | | Screw (mini-can) | |
| E12 | 12 mm | Candelabra Edison Screw | 7004-28 |
| | | (CES) | |
| E14 | 14 mm | Small Edison Screw (SES) | 7004-23 |
| E17 | 17 mm | Intermediate Edison Screw | 7004-26 |
| | | (IES) | |
| E26 | 26 mm | [Medium] (one-inch) | 7004-21A-2 |
| | | Edison Screw (ES or MES) | |
| E27 | 27 mm | [Medium] Edison Screw | 7004-21 |
| | | (ES) | |
| E29 | 29 mm | [Admedium] Edison Screw | |
| | | (ES) | |
| E39 | 39 mm | Single-contact (Mogul) | 7004-24-A1 |
| | | Giant Edison Screw (GES) | |
| E40 | 40 mm | (Mogul) Giant Edison | 7004-24 |
| | | Screw (GES) | |

Additionally, the base member of a lamp can be of any form factor configured to support electrical connections, which electrical connections can conform to any of a set of types or standards. For example Table 2 gives standards (see “Type”) and corresponding characteristics, including mechanical spacing between a first pin (e.g., a power pin) and a second pin (e.g., a ground pin).

TABLE 2

| | | Pin center to | | |
|---|---|---|---|---|
| Type | Standard | center | Pin Diameter | Usage |
| G4 | IEC 60061-1 | 4.0 mm | 0.65-0.75 mm | MR11 and other small halogens |
| | (7004-72) | | | of 5/10/20 watt and 6/12 volt |
| GU4 | IEC 60061-1 | 4.0 mm | 0.95-1.05 mm | |
| | (7004-108) | | | |
| GY4 | IEC 60061-1 | 4.0 mm | 0.65-0.75 mm | |
| | (7004-72A) | | | |
| GZ4 | IEC 60061-1 | 4.0 mm | 0.95-1.05 mm | |
| | (7004-64) | | | |
| G5 | IEC 60061-1 | 5 mm | | T4 and T5 fluorescent tubes |
| | (7004-52-5) | | | |
| G5.3 | IEC 60061-1 | 5.33 mm | 1.47-1.65 mm | |
| | (7004-73) | | | |
| G5.3-4.8 | IEC 60061-1 | | | |
| | (7004-126-1) | | | |
| GU5.3 | IEC 60061-1 | 5.33 mm | 1.45-1.6 mm | |
| | (7004-109) | | | |
| GX5.3 | IEC 60061-1 | 5.33 mm | 1.45-1.6 mm | MR16 and other small halogens |
| | (7004-73A) | | | of 20/35/50 watt and 12/24 volt |
| GY5.3 | IEC 60061-1 | 5.33 mm | | |
| | (7004-73B) | | | |
| G6.35 | IEC 60061-1 | 6.35 mm | 0.95-1.05 mm | |
| | (7004-59) | | | |
| GX6.35 | IEC 60061-1 | 6.35 mm | 0.95-1.05 mm | |
| | (7004-59) | | | |
| GY6.35 | IEC 60061-1 | 6.35 mm | 1.2-1.3 mm | Halogen 100W 120V |
| | (7004-59) | | | |
| GZ6.35 | IEC 60061-1 | 6.35 mm | 0.95-1.05 mm | |
| | (7004-59A) | | | |
| G8 | | 8.0 mm | | Halogen 100W 120V |
| GY8.6 | | 8.6 mm | | Halogen 100W 120V |
| G9 | IEC 60061-1 | 9.0 mm | | Halogen 120V (US)/230V (EU) |
| | (7004-129) | | | |
| G9.5 | | 9.5 mm | 3.10-3.25 mm | Common for theatre use, |
| | | | | several variants |
| GU10 | | 10 mm | | Twist-lock 120/230-volt MR16 |
| | | | | halogen lighting of 35/50 watt, |
| | | | | since mid-2000s |
| G12 | | 12.0 mm | 2.35 mm | Used in theatre and single-end |
| | | | | metal halide lamps |
| G13 | | 12.7 mm | | T8 and T12 fluorescent tubes |
| G23 | | 23 mm | 2 mm | |
| GU24 | | 24 mm | | Twist-lock for self-ballasted |
| | | | | compact fluorescents, since |
| | | | | 2000s |
| G38 | | 38 mm | | Mostly used for high-wattage |
| | | | | theatre lamps |
| GX53 | | 53 mm | | Twist-lock for puck-shaped |
| | | | | under-cabinet compact |
| | | | | fluorescents, since 2000s |

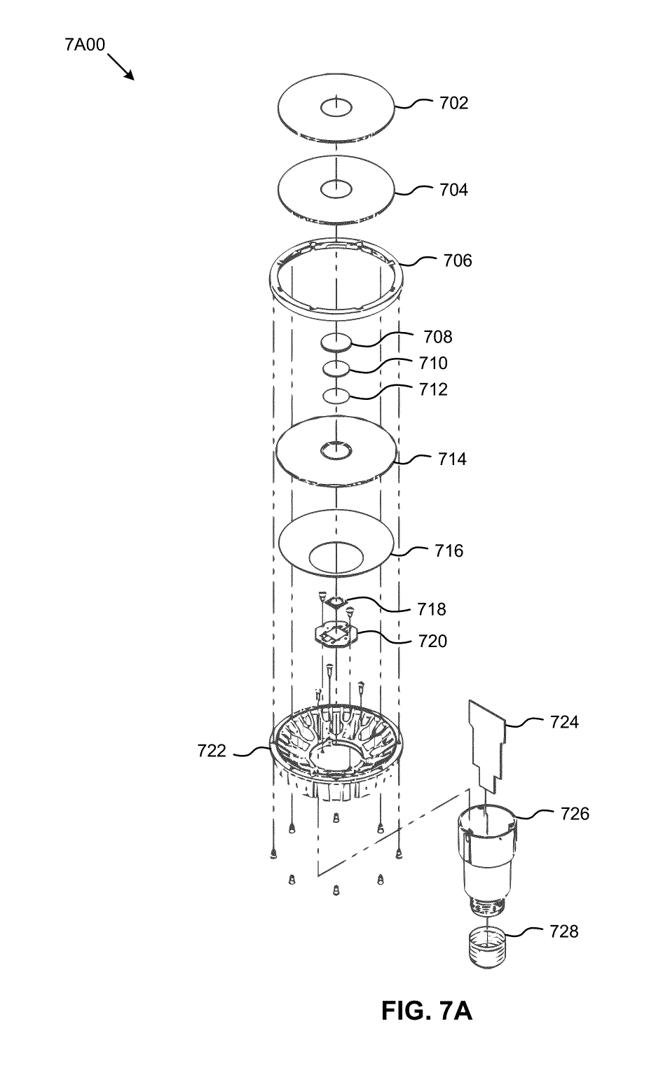

FIG. 7A depicts an embodiment of the present disclosure in the form of a lamp application. In a lamp application, one or more light emitting diodes are used in lamps and fixtures. Such lamps and fixtures include replacement and/or retro-fit directional lighting fixtures.

In some embodiments, aspects of the present disclosure can be used in an assembly. As shown in FIG. 7A, the assembly comprises:
a screw cap 728
a driver housing 726
a driver board 724
a heatsink 722
a metal-core printed circuit board 720
an LED light source 718
a dust shield 716
a lens 714
a reflector disc 712
a magnet 710
a magnet cap 708
a trim ring 706
a first accessory 704
a second accessory 702

Finally, it should be noted that there are alternative ways of implementing the embodiments disclosed herein. Accordingly, the present embodiments are to be considered as illustrative and not restrictive, and the claims are not to be limited to the details given herein, but may be modified within the scope and equivalents thereof.

What is claimed is:

1. A lamp comprising:
a light source
a light control apparatus connected to said lamp and comprising:
a first region;
a second region;
a connector for coupling said first region to said second region, wherein a cumulative refraction angle is selectable based upon a relative configuration of said first region with respect to said second region; and
a coupling element configured to couple said light source to said light control apparatus.

2. The lamp according to claim 1, wherein said first region and said second region assume a prismatic geometry.

3. The lamp according to claim 1, wherein a compound structure rotation angle of said first and second regions is selectable with respect to an axis.

4. The lamp according to claim 3, wherein said connector allows said first and second regions to be rotated together by the compound structure rotation angle around said axis while the relative rotation angle is fixed.

5. The lamp according to claim 3, wherein said compound structure rotation angle controls a steering direction.

6. The lamp according to claim 1, wherein said cumulative refraction angle is generated from a combination of a first refraction angle generated by said first region and a second refraction angle generated by said second region.

7. The lamp according to claim 1, wherein said connector further comprises a first element connector and a second element connector each of the first and second element connectors respectively comprising a base and a cap.

8. The lamp according to claim 6, wherein each base associated with said first and second element connectors is composed of a magnetic material.

9. The lamp according to claim 1, further comprising at least one angle setting mark, each angle setting mark corresponding to said cumulative refraction angle.

10. The lamp according to claim 2, wherein said first region and said second region respectively further comprise a planar surface and a non-planar surface.

11. The apparatus of claim 1, wherein said connector rotationally couples said first region to said second region, and wherein said relative configuration is a relative angle rotation.

12. The apparatus of claim 1, wherein said coupling element comprises a housing.

13. A method for controlling a light beam generated by a lamp comprising passing the light beam through a first refractive region and a second refractive region, said first and second refractive regions generating a composite refraction angle for said light beam selectable by a relative rotation of said first refractive region with respect to said second refractive region.

14. The method according to claim 13, further comprising selecting a rotational parameter of said first and second refractive regions with respect to an axis, said rotational parameter controlling a steering of the light beam.

15. The method according to claim 13, wherein said relative rotation of said first refractive region with respect to said second refractive region is an input parameter generated by a mechanical operation on said first and second refractive regions.

16. The method according to claim 13, wherein said first and second refractive regions assume a prismatic geometry.

17. A light control apparatus for steering light from a lamp having a light source, said light control apparatus comprising:
a first lens element, said first lens element comprising a first surface and a second surface, wherein said first and second surfaces generate a first refraction angle for said light from said light source of said lamp;
a second lens element, said second lens element comprising a third surface and a fourth surface, wherein said third and fourth surfaces generate a second refraction angle for said light;
a connector for selecting a relative rotation between said first lens element and said second lens element such that a cumulative refraction angle for said light is achieved based upon said first refraction angle and said second refraction angle.

18. The light control apparatus of claim 17, wherein said connector provides for a selection of a rotation angle of the first lens element and the second lens element with respect to an axis, wherein said relative rotation remains fixed and said rotation angle with respect to said axis controls a steering of the light.

19. The light control apparatus according to claim 17, wherein said connector further comprises a first element connector and a second element connector each of said first and second element connectors respectively comprising a base and a cap.

20. The light control apparatus according to claim 19, wherein each said base associated with said first and second element connectors is composed of a magnetic material.

21. The light control apparatus according to claim 17, further comprising at least one angle setting mark, each angle setting mark corresponding to said cumulative light refraction angle.

22. The light control apparatus according to claim 17, wherein said first and third surfaces are planar and the second and fourth surfaces are non-planar.
